(19) United States
(12) Patent Application Publication
(10) Pub. No.: US 2016/0370638 A1
(43) Pub. Date: Dec. 22, 2016

(54) LCD AND AN LC MODULE OF NARROW BEZEL THEREOF

(71) Applicants: SHENZHEN CHINA STAR OPTOELECTRONICS TECHNOLOGY CO., LTD., Shenzhen City, Guangdong (CN); WUHAN CHINA STAR OPTOELECTRONICS TECHNOLOGY CO., LTD., Wuhan, Hubei (CN)

(72) Inventor: Yanxue ZHANG, Shenzhen, Guangdong (CN)

(73) Assignee: Shenzhen China Star Optoelectronics Technology Co., Ltd., Shenzhen, Guangdong (CN)

(21) Appl. No.: 14/646,015

(22) PCT Filed: Feb. 28, 2015
(86) PCT No.: PCT/CN2015/073409

§ 371 Date: May 19, 2015

(30) Foreign Application Priority Data
Feb. 11, 2015 (CN) 201510073959.2

(51) Int. Cl. G02F 1/1333; G02F 1/1335

(52) U.S. Cl. CPC G02F 1/133308; G02F 1/1336; G02F 2201/48; G02F 2001/133314; G02F 2201/07; G02F 2201/46

(57) ABSTRACT

The present invention provides an LCD and an LC module of narrow bezel thereof. The LC module of narrow bezel includes a case; an LC panel; a BLU; and a buffer material, wherein the LC panel and the BLU are stacked in the case and widths of the LC panel and the BLU are the same. The buffer material is set on one side or two sides of a region between the BLU and the case. The present invention provides an LCD and an LC module of narrow bezel thereof. The widths of the LC panel and the BLU are the same and the buffer material is set on one side or two sides of a region between the BLU and the case so the interval between the LC module and the bezel (the case) becomes narrow and the narrow bezel of the LCD is performed.

### BACKGROUND

Technical Field

The present invention relates to a liquid crystal display (LCD), and more particularly, to an LCD and a liquid crystal (LC) module of narrow bezel thereof.

Description of the Related Art

With the evolution of optoelectronics, narrow bezel is an important design for module product. In the conventional module, the width of each side of the Backlight Unit (BLU) is usually about 0.3 mm (margin) wider than that of the panel, for avoiding that the panel is broken when it collides the bezel as assembling the module and the bezel. The bezel is also designed according to the largest dimension and this design encounters great difficulty.

FIG. 1 is the cross-sectional view of the conventional LC module and FIG. 2 is the front view of the conventional LC module of FIG. 1. Referring to FIGS. 1 and 2, each side of BLU is a little wider than that of the panel. The width is usually about 0.3 mm. Apparently, this design is not good to the narrow bezel of LCD because the margin between BLU and the bezel is necessary. In FIGS. 1 and 2, numeral 1 represents the panel, numeral 2 represents BLU, and numeral 3 represents the bezel.

### SUMMARY OF THE DISCLOSURE

An embodiment of the present invention is to provide an LCD and an LC module of narrow bezel thereof for solving the technical problem that the bezel of LCD is wide because each side of BLU is a little wider than that of the panel. The width is usually about 0.3 mm.

For solving the above problem, an embodiment of the present invention is to provide an LC module of narrow bezel including a case, an LC panel, and a BLU, wherein the LC panel and the BLU are stacked in the case and the widths of the LC panel and the BLU are the same.

The LC module further includes a buffer material set between the BLU and the case in accordance with another embodiment of the present invention.

The buffer material is set on one side or two sides of a region between the BLU and the case in accordance with another embodiment of the present invention.

A recess is set between the BLU and the case in accordance with another embodiment of the present invention, wherein the buffer material is set in the recess.

An engagement structure is set between the BLU and the case in accordance with another embodiment of the present invention, wherein the buffer material further includes a vertical supporter and a horizontal supporter. The vertical supporter includes a plurality of protrusions and the case and/or the BLU include a plurality of grooves. The shape of the protrusion is barbed and the housing part of the groove suits the protrusion.

The horizontal supporter of the buffer material is compressively connected with the bottom of the BLU or extended into the case in accordance with another embodiment of the present invention, and the permanent connection between the buffer material and the case or the BLU is performed.

A width of the buffer material is 0.3 mm in accordance with another embodiment of the present invention.

The buffer material is foam or rubber in accordance with another embodiment of the present invention.

For solving the above problem, the present invention is further to provide an LCD including the above LC module.

Comparing to the conventional technique, the LCD and the LC module of narrow bezel have the LC panel and the BLU with the same widths. The buffer material is set on one side or two sides of a region between the BLU and the case and the interval between the BLU and the case becomes narrow. The narrow bezel of the LCD is performed.

### BRIEF DESCRIPTION OF THE DRAWINGS

The accompanying drawings are included to provide easy understanding of the application, are incorporated herein and constitute a part of this specification. The drawings illustrate embodiments of the application and, together with the description, serve to illustrate the principles of the application.

FIG. 1 is a cross-sectional view of a conventional LC module structure.

FIG. 2 is a front view of the conventional LC module structure of FIG. 1.

FIG. 3 is a cross-sectional view of a LC module of narrow bezel in accordance with the first embodiment of the present invention.

FIG. 4 is a front view of the LC module of narrow bezel of FIG. 3.

FIG. 5 is a cross-sectional view of a LC module of narrow bezel in accordance with the second embodiment of the present invention.

FIG. 6 is a front view of the LC module of narrow bezel of FIG. 5.

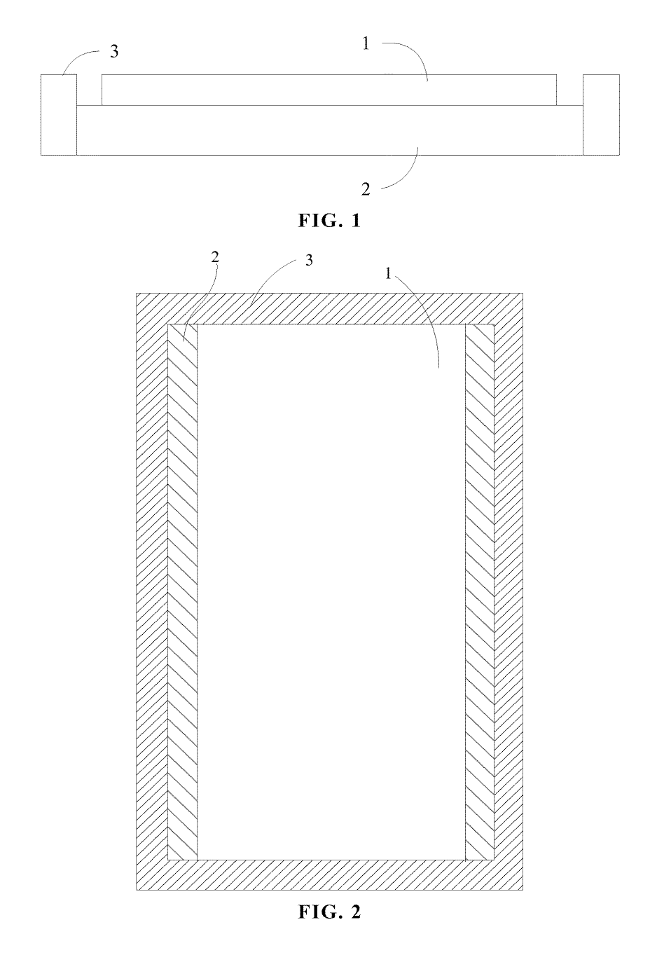

### DESCRIPTION OF THE PREFERRED EMBODIMENTS

To better and concisely explain the disclosure, the same name or the same reference number given or appeared in different paragraphs or figures along the specification should has the same or equivalent meanings while it is once defined anywhere of the disclosure.

The following shows the description of the embodiments of the present disclosure in accordance with the drawings.

### Embodiment 1

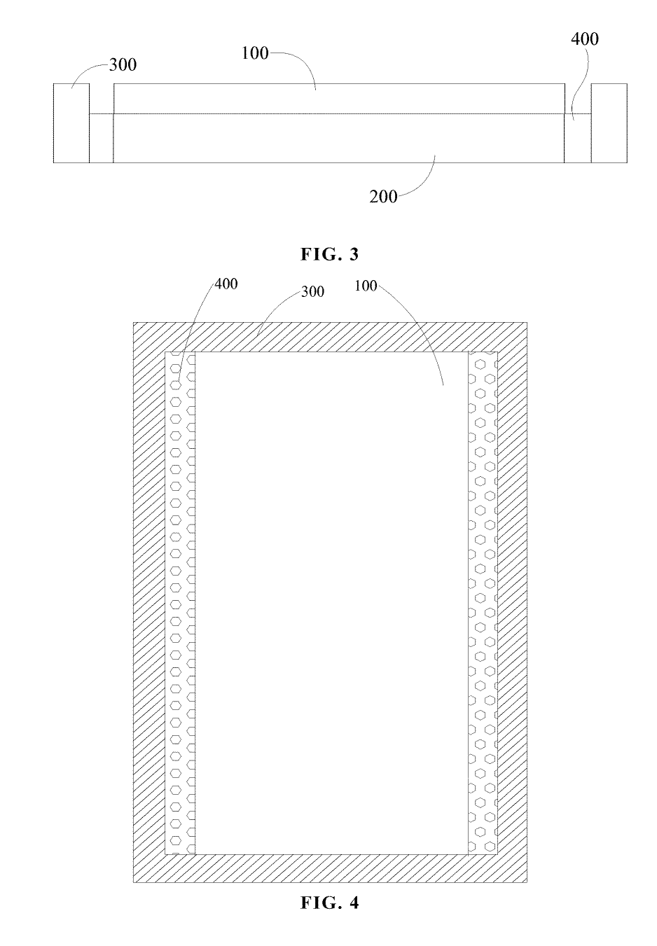

Referring to FIGS. 3 and 4, FIG. 3 is a cross-sectional view of a LC module of narrow bezel in accordance with the first embodiment of the present invention, and FIG. 4 is a front view of the LC module of narrow bezel of FIG. 3. The LC module of narrow bezel includes a case 300, a LC panel 100, and a BLU 200.

Specifically, the LC panel 100 and the BLU 200 are stacked in the case 300, wherein the widths of the LC panel 100 and the BLU 200 are the same.

Preferably, the LC module further includes a buffer material 400 set between the BLU 200 and the case 300, and the buffer material 400 is set on two sides of a region between the BLU 200 and the case 300. The buffer material 400 is foam, rubber, or other buffer materials. The examples are not listed repetitively.

A width of the buffer material is preferably 0.3 mm. It can, of course, be smaller than 0.3 mm such as 0.2 mm or 0.1 mm.

Preferably, a recess (not shown) is set between the BLU 200 and the case 300, housing the buffer material 400. The shape of the recess can be rectangular or other shapes which adapt to the contour of the buffer material 400. The width of the opening of the recess is larger than or equals to the thickness of the buffer material 400. The lowest plane of the opening and the bottom surface of the BLU 200 are at the same plane. A surface of the buffer material 400 is attached to the case 300 and another surface thereof is attached to the BLU 200.

In addition, an engagement structure (not shown) is set between the BLU 200 and the case 300, and the shape of the contour of the buffer material 400 can be L shape or T shape. The buffer material 400 further includes a vertical supporter and a horizontal supporter. The vertical supporter includes a plurality of protrusions, and the case 300 and the BLU 200 can include a plurality of grooves adapting to the plurality of protrusions. The shape of the protrusion is barbed and the housing part of the groove suits the protrusion. Besides the engagement structure is to fix the buffer material 400, the horizontal supporter of the buffer material 400 can be compressively connected with the bottom of the BLU 200 or extended into the case 300, and the permanent connection between the buffer material 400 and the case 300 or the BLU 200 is performed.

In the LC module of this embodiment, the widths of the LC panel 100 and the BLU 200 are the same and the edges thereof are smooth. The case 300 reserves tolerance on one side. The buffer material 400 is set on two sides of the BLU 200 and the width of one side of the buffer material 400 can be 0.3 mm. The buffer material 400 has buffer character so two sides of the buffer material 400 can be compressed to perform assembly. The interval between the LC module and the bezel (the case 300) becomes narrow. The narrow bezel of the LCD is performed.

### Embodiment 2

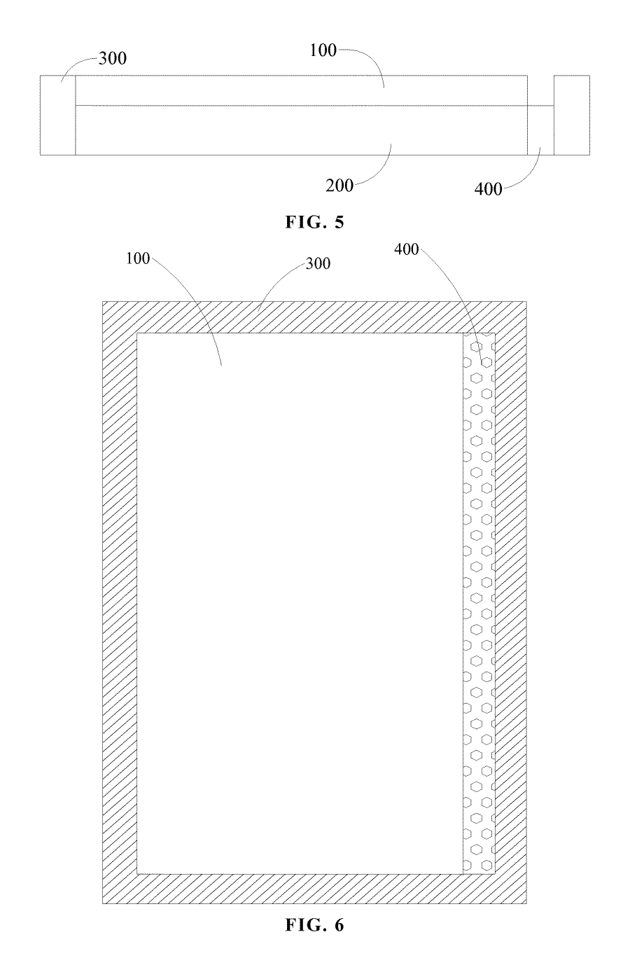

Referring to FIGS. 5 and 6, FIG. 5 is a cross-sectional view of a LC module of narrow bezel in accordance with the second embodiment of the present invention, and FIG. 6 is a front view of the LC module of narrow bezel of FIG. 5. The LC module of narrow bezel includes a case 300, a LC panel 100, and a BLU 200.

Specifically, the LC panel 100 and the BLU 200 are stacked in the case 300, wherein the widths of the LC panel 100 and the BLU 200 are the same.

Preferably, the LC module further includes a buffer material 400 set between the BLU 200 and the case 300, and the buffer material 400 is set on two sides of a region between the BLU 200 and the case 300. The buffer material 400 can be foam, rubber, or other buffer materials. The examples are not listed repetitively. A width of the buffer material 400 can be preferably 0.3 mm. It can, of course, be smaller than 0.3 mm such as 0.2 mm or 0.1 mm.

Preferably, a recess (not shown) is set between the BLU 200 and the case 300, where the buffer material 400 is set. The shape of the recess can be rectangular or other shapes which adapt to the contour of the buffer material 400. The width of the opening of the recess is larger than or equals to the thickness of the buffer material 400. The lowest plane of the opening and the bottom surface of the BLU 200 are at the same plane. A surface of the buffer material 400 is attached to the case 300 and another surface thereof is attached to the BLU 200.

In addition, an engagement structure (not shown) is set between the BLU 200 and the case 300, and the shape of the contour of the buffer material 400 can be L shape or T shape. The buffer material 400 further includes a vertical supporter and a horizontal supporter. The vertical supporter includes a plurality of protrusions and the case 300 and the BLU 200 can include a plurality of grooves adapting to the plurality of protrusions. The shape of the protrusion is barbed and the housing part of the groove suits the protrusion. Besides the engagement structure is to fix the buffer material 400, the horizontal supporter of the buffer material 400 can be compressively connected with the bottom of the BLU 200 or extended into the case 300, and the permanent connection between the buffer material 400 and the case 300 or the BLU 200 is performed.

The difference is that the buffer material 400 is set on one side of a region between the BLU 200 and the case 300 in this embodiment. It is not limited that the buffer material 400 is set on right side of the BLU 200 as shown in FIG. 5. In other embodiments, the buffer material 400 can be set on left side, top, or bottom of the BLU 200. It will be apparent to those having ordinary skill in the art. The examples are not listed repetitively.

In the LC module of this embodiment, the LC panel 100 and the BLU 200 are shifted to one side of the case 300. The LC panel 100 aligns the assembly when the BLU 200 and the case 300 are assembled to avoid the collision between the LC panel 100 and the case 300 and the damage of the LC panel 100. The buffer material 400 on the other side can be compressed to perform assembly effectively. The interval between the LC module and the bezel (the case 300) becomes narrower. The buffer material 400 is on one side of the BLU 200 and the width of the buffer material 400 is 0.3 mm generally. The narrow bezel of the LCD is performed.

In addition, the present invention is further to provide an LCD including the LC module of narrow bezel in the above embodiments. Other structures of the LCD will be apparent to those having ordinary skill in the art. The examples are not listed repetitively.

It will be apparent to those having ordinary skill in the art that various modifications and variations can be made to the devices in accordance with the present disclosure without departing from the scope or spirit of the disclosure. In view of the foregoing, it is intended that the present disclosure covers modifications and variations of this disclosure provided they fall within the scope of the following claims and their equivalents.

What is claimed is:

1. A liquid crystal (LC) module of narrow bezel, comprising:
a case;
an LC panel;
a backlight unit (BLU), wherein the LC panel and the BLU are stacked in the case and widths of the LC panel and the BLU are the same;
a buffer material, set on one side or two sides of a region between the BLU and the case; and
a recess set between the case and the BLU to house the buffer material, wherein the buffer material is set in the recess.

2. An LC module of narrow bezel, comprising:
a case;
an LC panel; and
a BLU, wherein the LC panel and the BLU are stacked in the case and widths of the LC panel and the BLU are the same.

3. The LC module of narrow bezel of claim 2, further comprising a buffer material set between the BLU and the case.

4. The LC module of narrow bezel of claim 3, wherein the buffer material is set on one side or two sides of a region between the BLU and the case.

5. The LC module of narrow bezel of claim 3, further comprising a recess set between the case and the BLU to house the buffer material, wherein the buffer material is set in the recess.

6. The LC module of narrow bezel of claim 3, further comprising an engagement structure set between the BLU and the case, wherein the buffer material further comprises a vertical supporter and a horizontal supporter, the vertical supporter comprises a plurality of protrusions, and the case and/or the BLU comprises a plurality of grooves adapting to the plurality of protrusions, the shape of the protrusion is barbed, and a housing part of the groove suits the protrusion.

7. The LC module of narrow bezel of claim 6, wherein the horizontal supporter of the buffer material is compressively connected with the bottom of the BLU or extended into the case, and the permanent connection between the buffer material and the case or the BLU is performed.

8. The LC module of narrow bezel of claim 3, wherein a width of the buffer material is 0.3 mm.

9. The LC module of narrow bezel of claim 8, wherein the buffer material is foam or rubber.

10. A liquid crystal display (LCD), comprising:
an LC module of narrow bezel, comprising:
a case;
an LC panel; and
a BLU, wherein the LC panel and the BLU are stacked in the case and widths of the LC panel and the BLU are the same.

11. The LCD of claim 10, further comprising a buffer material set between the BLU and the case.

12. The LCD of claim 11, wherein the buffer material is set on one side or two sides of a region between the BLU and the case.

13. The LCD of claim 11, further comprising a recess set between the case and the BLU to house the buffer material, wherein the buffer material is set in the recess.

14. The LCD of claim 11, further comprising an engagement structure set between the BLU and the case, wherein the buffer material further comprises a vertical supporter and a horizontal supporter, the vertical supporter comprises a plurality of protrusions and the case and/or the BLU comprises a plurality of grooves adapting to the plurality of protrusions, the shape of the protrusion is barbed, and a housing part of the groove suits the protrusion.

15. The LCD of claim 11, wherein the horizontal supporter of the buffer material is compressively connected with the bottom of the BLU or extended into the case, and the permanent connection between the buffer material and the case or the BLU is performed.

16. The LCD of claim 11, wherein a width of the buffer material is 0.3 mm.

17. The LCD of claim 16, wherein the buffer material is foam or rubber.
